(19) United States
(12) Patent Application Publication
(10) Pub. No.: US 2006/0254150 A1
(43) Pub. Date: Nov. 16, 2006

(54) Apparatus for supporting glass in a window assembly

(76) Inventor: William R. Van Kirk, Allison Park, PA (US)

Correspondence Address: Amy L. Crocetti, Esq.;Metz Lewis LLC, 18th Floor, 11 Stanwix Street, Pittsburgh, PA, 15222, US

(21) Appl. No.: 11/128,862

(22) Filed: May 13, 2005

(51) Int. Cl. E05D 7/00

(52) U.S. Cl. 49/397

(57) ABSTRACT

A support apparatus for supporting a glass unit in a window assembly including a support surface for holding and supporting the glass unit and a leg extending downwardly from the support surface for being received by the sash of the window assembly. Also, a window assembly including a sash, a glass unit, and a support apparatus. The glass unit of the window assembly rests on the support surface of the support apparatus and is attached to the corresponding hinge hardware, including the sash arm. By attaching the support apparatus to the sash arm, the sash does not have to act as a structural support and is less affected by deformation forces over time. The support apparatus may be made of a material having a coefficient of thermal expansion similar to that of glass, which helps to eliminate the problem of sash sag caused by deformation forces.

### FIELD OF THE INVENTION

The present invention relates to window assemblies, and in particular to an apparatus for supporting the glass portion of a fenestration window assembly such as, but not limited to, a casement, single or double hung, awning, basement or slider style window assembly.

### BACKGROUND OF THE INVENTION

FIG. 1 shows an isometric view of a portion of a conventional casement style window assembly 5. Window assembly 5 includes frame 10 which is anchored to an opening provided in a structure such as a house. Window assembly 5 further includes sash 15 which holds and supports glass unit 20 using a dual adhesive glazing tape. Sash 15 may be made of vinyl PVC. Glass unit 20 is shown in partial cross section in FIG. 1. In actuality, glass unit 20 is as large as and covers the entire interior of sash 15. Glass unit 20 preferably includes a base 25, which may be a spacer or divider, into which one or more sheets of glass (not shown) are mounted. Glass unit 20 may consist of, for example, two pieces of 2.5 mm glass and a spacer system used to separate the glass and create an insulated unit, although other configurations and/or materials could also be used. Alternatively, glass unit 20 may simply include one or more panes or sheets of glass.

As seen in FIG. 1, setting pad 30, typically made from neoprene rubber, is placed between glass unit 20 and sash 15. Setting pad 30 allows glass unit 20 to be mounted in a spaced apart relationship from sash 15 which helps prevent seal failure. Setting pad 30 also prevents the more rigid sash 15 from contacting the glass and causing cracks.

Referring again to FIG. 1, sash 15 is pivotably mounted to frame 10 by hinge 35, which includes hinge track 40 and sash arm 45. Isometric views of hinge track 40 and sash arm 45 are shown in FIGS. 2 and 3, respectively. Sash arm 45 includes a pivot end 50 and a sliding element 55. As seen in FIG. 1, hinge track 40 is affixed to frame 10 by screws 60, and sash arm 45 is affixed to the underside of sash 15 by screws (not shown). Sash arm 45 is in turn moveably attached to frame 10. In particular, pivot end 50 of sash arm 45 is pivotably attached to hinge track 40 using pin 65, and sliding element 55 is slideably mounted to hinge track 40 under flange 70. Thus, as will be appreciated, window assembly 5 may be opened and closed by operating hinge 35 to move sash 15. Specifically, an operator element (not shown) is attached to the sash 15 that enables an individual to slide sliding element 55 along hinge track 40 while pivot end 50 pivots about pin 65, thereby moving sash 15 and opening and closing window assembly 5.

Typically, frame 10 and/or sash 15 are made of a material, such as vinyl or wood, which have a tendency to sag or otherwise deform over time. Deformation can occur for various reasons including poor installation, poor design or the amount of time the sash is in an open position while exposed to normal climate conditions.

As will be appreciated, downward forces are applied to the junction between glass unit 20 and sash 15 when window assembly 5 is open and sash 15 is not fully supported by frame 10. This open window position puts a bending force or torque on the system between the frame, sash and glass. Accordingly, stiffness of the sash and/or frame is a very important characteristic of the window assembly. The modulus of elasticity is measurement of the stiffness of a material when stress is applied. Glass has a modulus of elasticity equal to 9.8×10⁶ psi, vinyl has a modulus of elasticity equal to 0.33×10⁶ psi, and wood has a modulus of elasticity equal to 1.6×10⁶ psi. In a window system, the higher modulus of elasticity of the glass unit 20 causes these bending or deformation forces to be primarily localized and absorbed by the sash.

Other forces localize deformation in the sash. For example, temperature changes in the case of a sash made of a material such as vinyl and wood having a coefficient of thermal expansion higher than that of glass. Glass has a coefficient of thermal expansion equal to 4.762×10⁻⁶/° F., while vinyl has a coefficient of thermal expansion equal to 3.35×10⁻⁵/° F. and wood has a coefficient of thermal expansion equal to 2×10⁻⁶/° F. to 32×10⁻⁶/° F., which is influenced by factors such as the cut and grain of the wood. Under these conditions, a sash 15 may expand and contract causing the glass unit 20 to move within sash 15 or sag to an out of square position. As a result, this may cause difficulty in closing and/or locking window assembly 15. Similar sag problems exist for other window styles, such as single or double hung, awning, basement, and slider window styles.

### SUMMARY OF THE INVENTION

The present invention relates to a support apparatus for receiving a glass unit in a window assembly. The window assembly of the present invention may be any one of a casement style, a single or double hung style, an awning style, a basement style, tilt and turn style and a slider style window assembly.

The support apparatus includes a support surface for supporting the glass unit and a leg extending downwardly from the support surface which may be received by the sash of the window assembly. The leg may be used to attach the support apparatus to the sash arm of the window assembly which in turn is attached to the frame. The hardware and sash gain the stiffness of the glass and do not rely as much upon each part of the connection for structural support, such as hardware to sash and sash to glass connections. The apparatus helps to reduce the need of the sash to act as a structural member to support the glass unit and reduces the adverse effects of temperature, gravitational, and other deforming forces over time on the sash to glass unit connection as described with respect to the prior art.

The apparatus may further include a first side wall extending upwardly from the support surface. In a preferred embodiment, the support surface and the leg form a first assembly of the apparatus, wherein the apparatus further includes a second assembly that may be selectively attached to the first assembly, the second assembly including a second upwardly extending side wall. The first and second assemblies may be connected to one another by way of a mating tongue and groove.

The present invention also relates to a window support assembly including a sash, a glass unit, and a support apparatus received by the sash, wherein the support apparatus has a support surface and wherein the glass unit is supported by the support surface. The support apparatus may further include a leg extending downwardly from the support surface. The sash may further include a hole into which the leg is inserted, wherein the leg is attached to a bottom frame member of the sash. In one particular embodiment, the window assembly further includes a frame and hardware such as a sash arm attached to the sash and to the frame. In this embodiment, the support apparatus is attached to the hardware. The support apparatus of the window assembly may further include a first side wall extending upwardly from the support surface. The support apparatus may be formed of a first assembly including the support surface and a second assembly selectively attachable to the first assembly, wherein the second assembly includes a second upwardly extending side wall. The first and second assemblies may be selectively attachable to one another by way of a matching tongue and groove or other known mechanisms.

In one specific embodiment, the sash of the window assembly is made of vinyl, which has a coefficient of thermal expansion that is greater than that of glass. The support apparatus is constructed of a material having a coefficient of thermal expansion that is similar or close to that of glass. The support apparatus expands and contracts in a manner similar to that of the glass unit. The expected movement of the sash of the window assembly is much greater but has little effect as a deforming force of the window assembly because the support apparatus minimizes the function of the sash as a structural support.

The window assembly may further include an additional support apparatus attached to the sash which provides an additional support surface for receiving and supporting the glass unit. The support apparatus and the additional support apparatus are attached to the bottom frame member and top frame member, respectively, of the sash.

### BRIEF DESCRIPTION OF THE DRAWINGS

Further features and advantages of the present invention will be apparent upon consideration of the following detailed description of the present invention, taken in conjunction with the following drawings, in which like reference characters refer to like parts, and in which:

FIG. 1 is an isometric view of a portion of a conventional casement style window assembly;

FIG. 2 is an isometric view of a hinge track forming a part of the window assembly shown in FIG. 1;

FIG. 3 is an isometric view of a sash arm forming a part of the window assembly shown in FIG. 1;

FIGS. 4 and 5 are isometric and end plan views, respectively, of a support apparatus according to the present invention; and

FIG. 6 is an isometric view of a portion of a casement style window assembly incorporating the support apparatus shown in FIGS. 4 and 5 according to an aspect of the present invention.

FIG. 6A is a second isometric view of a portion of a casement style window assembly incorporating the support apparatus shown in FIGS. 4 and 5 according to an aspect of the present invention.

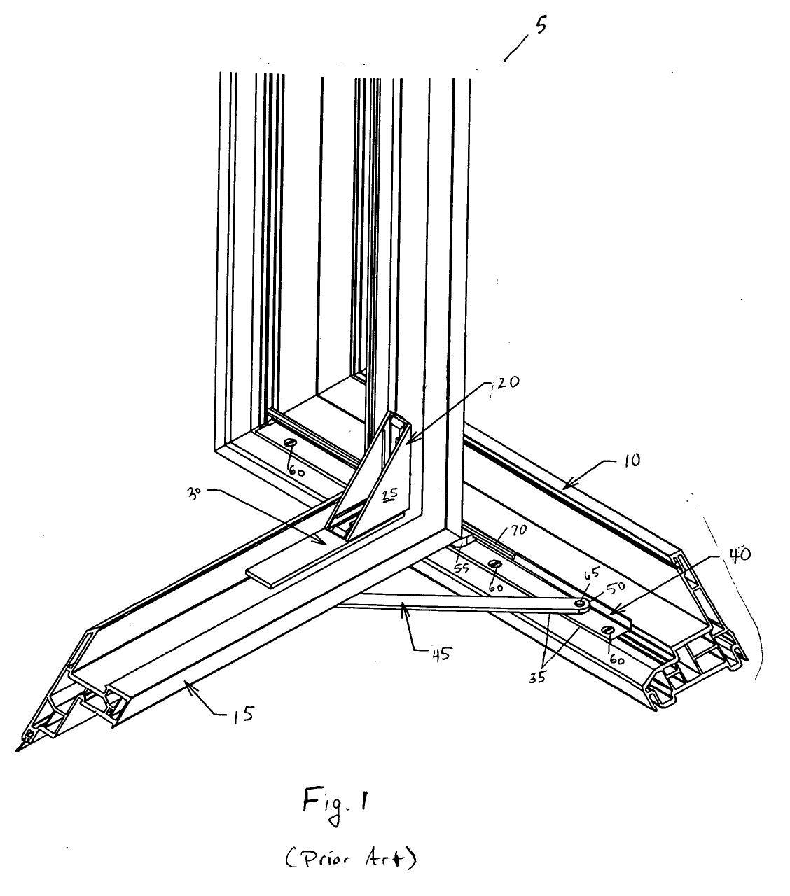

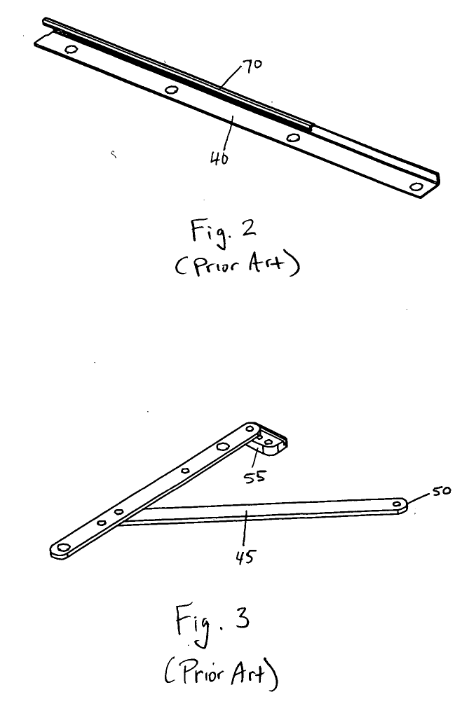

### DESCRIPTION OF THE PREFERRED EMBODIMENTS

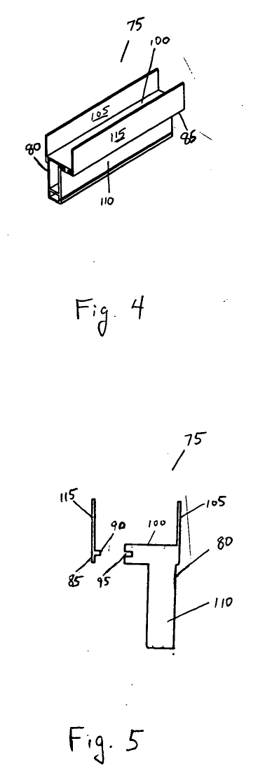

Referring to FIGS. 4 and 5, isometric and end plan views, respectively, of support apparatus 75 according to the present invention are shown. As described herein, support apparatus 75 is designed to hold and support a glass unit in a window assembly. According to the preferred embodiment of the present invention, support apparatus 75 includes two separate pieces as shown in FIG. 5, mounting and support piece 80 and enclosing piece 85. Mounting and support piece 80 and enclosing piece 85 are configured to be selectively attached to one another as shown in FIG. 4. In particular, mounting and support piece 80 includes support surface 100, upwardly extending side wall 105, and downwardly extending leg 110. Enclosing piece 85 includes a wall portion 115 having a tongue 90 extending generally perpendicular opposite the wall portion 115. The tongue 90 of enclosing piece 85 is adapted to fit within groove 95 which is provided in mounting and support piece 80. Alternatively, tongue 90 may be provided in mounting and support piece 80 and groove 95 may be provided in enclosing piece 85. Other known mechanisms for attaching support piece 80 to enclosing piece 85 are possible, such as a snap hook or a ball socket. Thus, when assembled as shown in FIG. 4, upwardly extending side wall 105 and wall portion 115 provides a boundary on either side of support surface 100.

According to the preferred embodiment of the present invention, support apparatus 75 is made of a material having sufficient strength to carry the forces from glass unit 20 and a coefficient of thermal expansion that is similar or close to that of glass. Preferably, the coefficient of thermal expansion of the material of support apparatus 75 will be less than 16×10⁻⁶. Acceptable materials for construction of support apparatus 75 having a coefficient of thermal expansion within the preferred range may include aluminum, die cast zinc, stainless steel, steel, nylon and plastic. Support apparatus 75 is four inches long, making the total expected expansion and contraction thereof for a 100° F. swing in temperature minimal, being on the order of <0.005 inches.

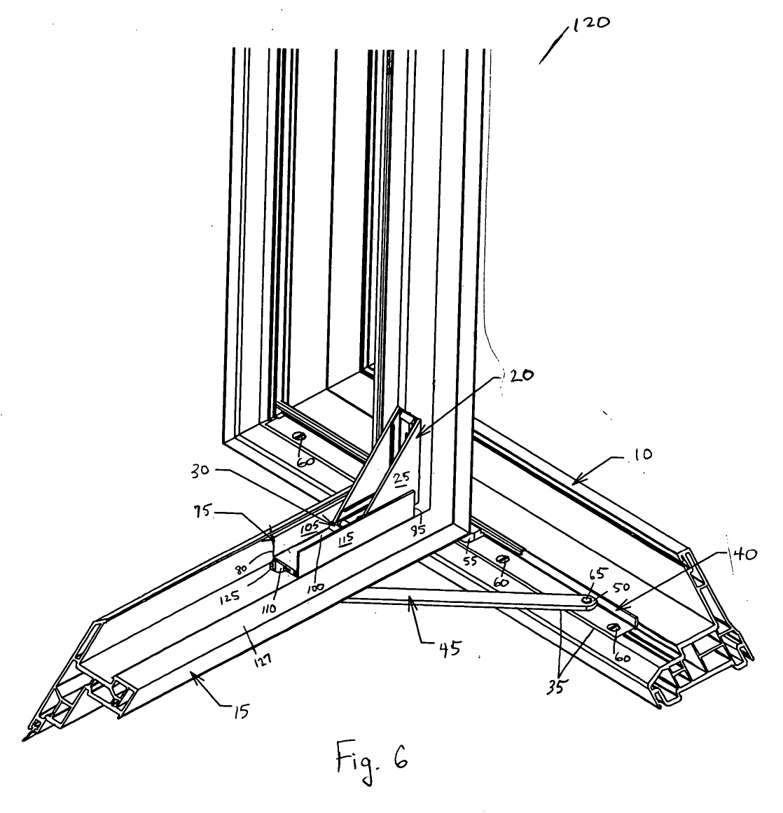

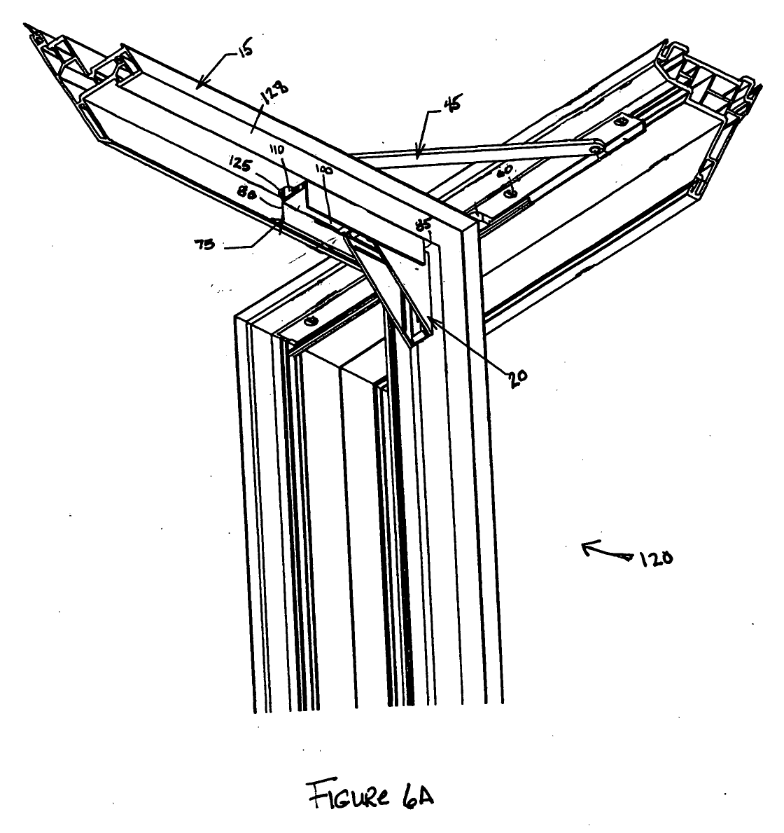

Referring to FIG. 6, an isometric view of a portion of a casement style window assembly 120 according to an aspect of the present invention is shown into which support apparatus 75 has been incorporated to hold and support glass unit 20. Support apparatus 75 is received by sash 15. Specifically, in the embodiment shown in FIG. 6, a hole 125 is provided in the bottom frame member 127 of sash 15 that preferably extends at least partially along the bottom surface of sash 15 in the form of a slot for the purpose of receiving leg 110 of support apparatus 75. Mounting and support piece 80 of support apparatus 75 is inserted into hole 125 and fastened in place by screws or the like inserted up through sash arm 45 and the bottom surface of sash 15 and into the bottom of leg 110, or solely through sash arm 45 if hole 125 extends all of the way through the bottom surface of sash 15.

Glass unit 20 is inserted inside sash 15 in a position in which it rests on support surface 100 of support apparatus 75. Preferably, an adhesive such as silicone, glue, tape or epoxy is provided on support surface 100 to attach glass unit 20 to support apparatus 75. After glass unit 20 is secured in place, enclosing piece 85 is attached to mounting and support piece 80 by inserting tongue 90 into groove 95. A structural silicone or similar adhesive material is preferably used to secure enclosing piece 85 to support piece 80.

Support apparatus 75 has been incorporated into an top frame member 128 of sash 15 to hold and support glass unit 20. For placement in this location, a hole 125 is provided in the top frame member 128 of sash 15 that preferably extends at least partially along the top surface of sash 15 in the form of a slot for the purpose of receiving leg 110 of support apparatus 75. Mounting and support piece 80 of support apparatus 75 is inserted into hole 125 and fastened in place by screws, or the like, inserted down through sash arm 45 and the top surface of sash 15 and into one end of leg 110, or solely through sash arm 45 if hole 125 extends all of the way through the top surface of sash 15. Glass unit 20 is inserted inside sash 15 in a position adjacent to support surface 100 of support apparatus 75. Glass unit 20 may be attached to support surface 100, as previously described with respect to FIG. 6. After glass unit 20 is secured in place, enclosing piece 85 is attached and secured to mounting and support piece 80, as previously described with respect to FIG. 6.

Although only a single support apparatus 75 positioned in a single corner of sash 15, as shown in FIG. 6 and FIG. 6A, it can be appreciated that multiple support apparatuses 75 may be received by, and preferably attached to, sash 15 for purposes of receiving and supporting glass unit 20. It may be appreciated by one skilled in the art that, in this embodiment, a support apparatus may be provided in two corners of the sash having the corresponding hinge hardware. Each additional support apparatus 75 is identical in appearance and function and provides additional support for glass unit 20. The location of each additional support apparatus 75 is dependant upon the style of window. Specifically, for casement style window assembly 120, as described in FIG. 6 and FIG. 6A, a support apparatus 75 can be provided in bottom frame member 127, and an additional support apparatus 75 can be provided in top frame member 128 directly above the support apparatus located in bottom frame member 127.

Furthermore, it will be appreciated that the preferred two piece construction of support apparatus 75 is advantageous, especially when more than one support apparatus 75 is used in window assembly 120, because it allows glass unit 20 to be easily slid in place in position on top of the support surface 100 of each support apparatus 75 before each enclosing piece 85 is attached to each mounting and support piece 80. The present invention is not limited, however, to a two piece support apparatus 75. A single piece construction may also be used without departing from the scope of the present invention.

Thus, in window assembly 120, glass unit 20 is supported by one or more support apparatuses 75, having a coefficient of thermal expansion similar or close to that of glass, which can support the weight of glass unit 20 and transfer it to the corresponding hinge hardware, specifically hinge 35 and sash arm 45, and then to frame 10. This is in contrast to prior art window assemblies, such as window assembly 5, in which glass unit 20 is supported directly by sash 15. As a result, the sag problem described above is eliminated because the one or more support apparatuses 75 that hold and support glass unit 20 are attached directly to the corresponding hinge hardware, specifically, hinge 35 including sash arm 45, and will expand and contract minimally with temperature changes in an amount similar to the expansion and contraction in glass unit 20. Sash 15, made of vinyl or wood, will expand and contract significantly more than the glass in glass unit 20 because it has a higher coefficient of thermal expansion and is longer. For example, for a four inch long aluminum support apparatus 75, the expected movement for a 100° F. swing in temperature is approximately 0.005 inches and for glass the expected movement over the same four inches is approximately 0.0001 inches. In contrast, for a 24 inch wide vinyl sash 15, wherein sash 15 is supporting the glass, the expected movement for a 100° F. swing in temperature would be approximately 0.0804 inches, while the expected movement of glass over the same 24 inches would be approximately 0.0005 inches.

While support apparatus 75 of the present invention has been described in FIG. 6 in connection with a casement style window assembly, it should be noted that one or more support apparatuses 75 may be received in the sashes of and attached to the hardware of other styles of window assemblies, such as, but not limited to, single or double hung, awning, basement, tilt and turn and slider styles.

The terms and expressions which have been employed herein are used as terms of description and not as limitation, and there is no intention in the use of such terms and expressions of excluding equivalents of the features shown and described or portions thereof, it being recognized that various modifications are possible within the scope of the invention claimed. Although particular embodiments of the present invention have been illustrated in the foregoing detailed description, it is to be further understood that the present invention is not to be limited to just the embodiments disclosed, but that they are capable of numerous rearrangements, modifications and substitutions.

What is claimed is:

1. An apparatus for supporting a glass unit in a window assembly having a sash, comprising:
a support surface for receiving and supporting said glass unit; and
a leg extending downwardly from said support surface for insertion into said sash.

2. An apparatus according to claim 1, said window assembly further comprising a frame and hardware for attaching said sash to said frame, said leg being supported by said hardware.

3. An apparatus according to claim 1, further comprising a first side wall extending upwardly from said support surface.

4. An apparatus according to claim 3, said support surface and said leg comprising a first assembly of said apparatus, said apparatus further comprising a second assembly selectively attachable to said first assembly, said second assembly comprising a wall portion.

5. An apparatus according to claim 4, said first assembly and second assembly being selectively affixed by a tongue and groove joint.

6. An apparatus according to claim 1, said support surface and said leg comprising a first assembly of said apparatus, said apparatus further comprising a second assembly selectively attachable to said first assembly, said second assembly comprising a wall portion.

7. An apparatus according to claim 7, said first assembly and second assembly being selectively affixed by a tongue and groove joint.

8. An apparatus according to claim 1, said glass unit having glass having a first coefficient of thermal expansion, said support surface and said leg being constructed of a material having a second coefficient of thermal expansion similar to said first coefficient of thermal expansion.

9. An apparatus according to claim 1, said support surface and said leg being constructed of a material having a coefficient of thermal expansion similar to that of glass.

10. An apparatus according to claim 1, said support surface and leg being constructed of a material having a coefficient of thermal expansion less than 16 X 10-6.

11. An apparatus according to claim 1, said support surface and leg being constructed of a material selected from the group consisting of aluminum, die cast zinc, stainless steel, nylon and plastic.

12. A window assembly, comprising:
a sash;
a glass unit mounted within said sash; and
a support apparatus selectively received by said sash, said support apparatus having a support surface, said glass unit being supported within said sash by said support surface.

13. A window assembly according to claim 12, said support apparatus further comprising a leg extending downwardly from said support surface to selectively engage said sash.

14. A window assembly according to claim 13, said leg being selectively inserted into a bottom surface of said sash.

15. A window assembly according to claim 12, further comprising a frame and hardware for attaching said sash to said frame, said support apparatus being supported by said hardware.

16. A window assembly according to claim 15, said support apparatus further comprising a leg extending downwardly from said support surface for insertion into said sash.

17. A window assembly according to claim 16, said leg being supported by said hardware.

18. A window assembly according to claim 17, said hardware comprising a sash arm.

19. A window assembly according to claim 15, said hardware comprising a sash arm.

20. A window assembly according to claim 12, said glass unit including a base and one or more sheets of glass.

21. A window assembly according to claim 12, said support apparatus further comprising a first side wall extending upwardly from said support surface.

22. A window assembly according to claim 21, said support apparatus comprising a first assembly including said support surface and a second assembly selectively attachable to said first assembly, said second assembly comprising a wall portion.

23. A window assembly according to claim 22, said first assembly and said second assembly being selectively affixed by a tongue and groove joint.

24. A window assembly according to claim 12, said support apparatus comprising a first assembly including said support surface and a second assembly selectively attachable to said first assembly, said second assembly comprising a wall portion.

25. A window assembly according to claim 24, further comprising a frame and hardware for attaching said sash to said frame, said support apparatus being supported by said hardware.

26. A window assembly according to claim 25, said support apparatus further comprising a leg extending downwardly from said support surface for insertion into said sash.

27. A window assembly according to claim 26, said leg being supported by said hardware.

28. A window assembly according to claim 27, said hardware comprising a sash arm.

29. A window assembly according to claim 24, said first assembly and said second assembly being selectively affixed by a tongue and groove joint.

30. A window assembly according to claim 13, said support apparatus further comprising a side wall and a wall portion extending upwardly from said support surface.

31. A window assembly according to claim 12, said glass unit having glass having a first coefficient of thermal expansion, said support apparatus being made of a material having a second coefficient of thermal expansion similar to said first coefficient of thermal expansion.

32. A window assembly according to claim 12, said support apparatus being made of a material having a coefficient of thermal expansion similar to that of glass.

33. A window assembly according to claim 12, said support surface and leg being constructed of a material having a second coefficient of thermal expansion less than 16 X 1I 0-=b

34. A window assembly according to claim 12, said support surface and leg being constructed of a material selected from the group consisting of aluminum, die cast zinc, stainless steel, steel, nylon and plastic.

35. A window assembly according to claim 31, said sash being made of vinyl.

36. A window assembly according to claim 32, said sash being made of vinyl.

37. A window assembly according to claim 12, further comprising a setting pad located between said glass unit and said support surface.

38. A window assembly according to claim 12, further comprising an additional support apparatus received by said sash, said additional support apparatus having a support surface, said glass unit being supported by the support surface of said additional support apparatus.

39. A window assembly according to claim 12, said sash having a top frame member, a bottom frame member, and first and second side frame members, said support apparatus being received by said bottom frame member.

40. A window assembly according to claim 3 8, said sash having a top frame member, a bottom frame member, and first and second side frame members, said support apparatus being received by said bottom frame member and said additional support apparatus being received by said top frame member.

41. A window assembly according to claim 12, said window assembly being selected from the group consisting of casement, single or double hung, awning, basement, tilt and turn and slider style window assemblies.
